(19) United States
(12) Patent Application Publication
(10) Pub. No.: US 2014/0171244 A1
(43) Pub. Date: Jun. 19, 2014

(54) LEAF SPRING TENSIONER FOR A CENTERED POSITION IN THE ENGINE

(71) Applicant: Schaeffler Technologies AG & Co. KG, Herzogenaurach (DE)

(72) Inventor: Christian Hartmann, Falkendorf (DE)

(73) Assignee: Schaeffler Technologies AG & Co. KG, Herzogenaurach (DE)

(21) Appl. No.: 14/074,483

(22) Filed: Nov. 7, 2013

(30) Foreign Application Priority Data
Dec. 13, 2012 (DE) DE102012223081.5

(51) Int. Cl. F16H 7/08

(52) U.S. Cl. CPC F16H 7/08
USPC 474/111

(57) ABSTRACT

A traction device tensioner for a traction device drive of an internal combustion engine, comprising a tensioning element whose front makes contact with the traction device and whose rear faces away from it, and also including a spring that is positively affixed to the tensioning element and that serves to make contact with a support element that is separate from the traction device tensioner, whereby a first end of the spring is positively affixed to a rear holding section of the tensioning element, whereby a second end of the spring is fastened to the rear of the tensioning element via snap-on and/or clip connections. A traction device drive having such a traction device tensioner.

This claims the benefits of German Patent Application DE 10 2012 223 081.5, filed Dec. 13, 2012 and hereby incorporated by reference herein.

The invention relates to a traction means tensioner for a traction means drive of an internal combustion engine, comprising a tensioning element whose front makes contact with the traction means and whose rear faces away from it, and it also has a spring that is positively affixed to the tensioning element and that serves to make contact with a support element that is separate from the traction means tensioner, whereby a first end of the spring is positively affixed to a rear holding section of the tensioning element.

### BACKGROUND

The state of the art, for instance, German utility model DE 20 2007 002 854 U1, discloses a tensioning rail having a push-and-turn connector. This document describes a tensioning rail for a chain drive, comprising a base element and a leaf spring installed under pre-tension on the base element, whereby the leaf spring is supported on two sections of the base element at a distance from each other, and it is secured on at least one of the sections by means of a push-in connector, whereby the push-in connector is configured as a push-and-turn connector which—when in a release position in which the leaf spring is arranged perpendicular to the base element—releases the leaf spring and—when in a securing position in which the leaf spring runs in the same plane as the base element—locks the leaf spring onto the base element.

A similar solution is also known from German utility model DE 20 2007 005 472 U1. This document discloses a tensioning rail having a mating channel for a leaf spring. In particular, it describes a tensioning rail for a chain drive, comprising a base element and a leaf spring installed on the base element, whereby the leaf spring is supported on two fastening sections of the base element that are at a distance from each other, whereby the leaf spring is secured on the one fastening section by means of a plug-in pin that is inserted into an opening in the leaf spring, whereby the plug-in pin has a shank and a head, whereby the head extends laterally beyond the shank in the longitudinal direction of the leaf spring, and the opening has a cross section that is adapted to the shape of the insertion cross section of the head, while another fastening section has a mating channel that receives the end face and, in certain areas, the top or bottom of the leaf spring. The distance from the opening to the end face of the leaf spring received in the mating channel is greater than the distance from the end face received in the mating channel to the head of the plug-in pin. In a basic position of the leaf spring, the center line of the shank is arranged so as to be offset with respect to the center line of the opening.

### SUMMARY OF THE INVENTION

However, there are also torsion spring tensioners that require excessive installation space and that are unstable since they are only supported on one side.

Moreover, the prior-art leaf spring tensioners are too complicated to install.

It is an object of the present invention to provide an improvement for traction means drives used in internal combustion engines, especially an improvement that allows an easy-to-produce and easy-to-install leaf spring tensioner for a centered position in the engine. It is also an objective to avoid the drawbacks of the state of the art and to optimize the accommodation of a leaf spring on a tensioning element—which can also be referred to as the base element—in terms of its production characteristics, sturdiness and installation.

The present invention provides that a second end of the spring is fastened to the rear of the tensioning element by means of snap-on and/or clip connections.

In other words, a one-piece or two-piece tensioning rail with a clipped-on leaf spring is made possible. These rails can be produced with a simple open-closed mold. No additional gate is necessary, thus reducing the mold costs. Moreover, the installation is simplified. The leaf spring does not require any openings, especially holes, of the type needed in the state of the art. This accounts for a cost reduction. The geometry for the accommodation of the leaf springs allows the use of one or more individual leaf springs to form a spring packet whenever increased pre-tensioning forces are needed. The targeted design of the traction means tensioner, especially due to the targeted specification of the distance between the rear of the tensioning element and the side of the leaf spring that faces the rear of the tensioning element, makes it possible to establish the requisite pre-tensioning between the spring and the rail. It is possible to insert the spring non-rotatably into a shaft of the tensioning element, preferably with merely a linear or pivoting movement in the direction of the tensioning element.

It remains possible to mount the tensioning rail by means of a bolt or a collar screw so that it can make a rotational movement relative to the engine. The tensioning rail is supported by means of the leaf spring on the support element at a contact point, for instance, a bolt or a place on the contour of the engine. In particular, the tensioning rail is supported in the center, between the two holders on the engine, thus creating the necessary pre-tensioning force for pre-tensioning the traction means such as a chain or a belt, and for making the adjustments needed because of wear and tear of the chain. It is possible to provide reinforced wraparounds that allow a sturdier configuration in comparison to the state of the art and that translate into enhanced operational safety.

Thus, it is advantageous for the first end of the spring, preferably a first end edge of the spring and/or an end surface, to be surrounded, at least partially, by a first projection formed at the rear of the tensioning element. The projection can be configured as a latching tab. It is easily possible to insert the first end into a channel formed by the projection. Therefore, the projection functions along the lines of a long wraparound.

It is also advantageous for one or more hooks to be formed on the spring, creating a positive connection to the tensioning element, or else for a second projection to be formed at the rear of the tensioning element which surrounds the second end of the spring, at least partially. This second projection can also be configured as a latching tab in such a manner that it gives rise to a short wraparound with the second end of the spring. In this case as well, the leaf spring inserted into the shaft formed by the first projection can be clipped into or snapped onto the tensioning element by simply pressing on the spring in the direction of the tensioning element.

An embodiment that is easy to install is obtained when the second projection surrounds a second end edge of the spring, at least partially, and/or another end surface in order to bring about a positive connection to the tensioning element.

The failure safety is enhanced when the first projection extends further along the spring than the second projection does. The long wraparound is then created in the area of the first projection, and a short wraparound is created in the area of the second projection. The distance from the axial contact point of the first end of the spring with the tensioning element to the second axial contact point on the second end of the (leaf) spring with the tensioning element is smaller than the axial length of the (leaf) spring. Consequently, lᵣₐᵢₗ is greater than l_{leafspring}. The distance from the first contact point to the tip of the latching tab, that is to say, the length l_{latchingtab}, is also smaller than those two values.

An advantageous embodiment is also characterized in that the first projection is 1.5 to 5 times longer than the second projection as seen in the lengthwise direction of the spring. Easy insertion and installation of the (leaf) spring on the tensioning element are achieved, while also increasing the failure safety.

The costs can be reduced if the spring is configured as a mechanical spring, especially as a leaf spring. Particularly advantageous is the use of a leaf spring made of spring steel.

When two hooks on both sides of the spring protrude in the direction of the tensioning element and extend behind it, at least in certain sections, simple means are sufficient to prevent the leaf spring from slipping out perpendicular to the lengthwise direction of the tensioning element. In this context, it is also advantageous for one or both channels in which the appertaining end of the spring is inserted to be closed on one or both sides. The closure can be in the form of a web or as a wall.

It is likewise advantageous if there are recesses into which the hooks engage on the sides of the tensioning element, so that an efficient positive connection can be achieved. In this context, it is advantageous if a protruding edge that is present, at least in certain sections on one side and/or on both sides of the tensioning element, is formed at the rear of the tensioning element perpendicular to the lengthwise direction.

Finally, the invention also relates to a traction means drive having a tensioning element according to the invention.

### BRIEF DESCRIPTION OF THE DRAWINGS

The invention will be described in greater detail below, also with reference to a drawing showing two different variants of the tensioning element according to the invention. The following is shown:

FIG. 1 a front view of a first embodiment of a traction means tensioner according to the invention;

FIG. 2 a rear view of the traction means tensioner from FIG. 1;

FIG. 3 a perspective view of the traction means tensioner from FIGS. 1 and 2;

FIG. 4 another perspective view of the traction means tensioner from FIGS. 1 to 3 from a direction different from the one that serves as the basis for the depiction according to FIG. 3;

FIG. 5 a front view of a second embodiment of a traction means tensioner according to the invention;

FIG. 6 a rear view of the traction means tensioner from FIG. 5;

FIG. 7 a first perspective front view of the traction means tensioner from FIGS. 5 and 6; and

FIG. 8 a perspective rear view of the traction means tensioner from FIGS. 5 to 7.

### DETAILED DESCRIPTION

The figures are only of a schematic nature and merely serve to explain the invention. Identical elements are designated by the same reference numerals.

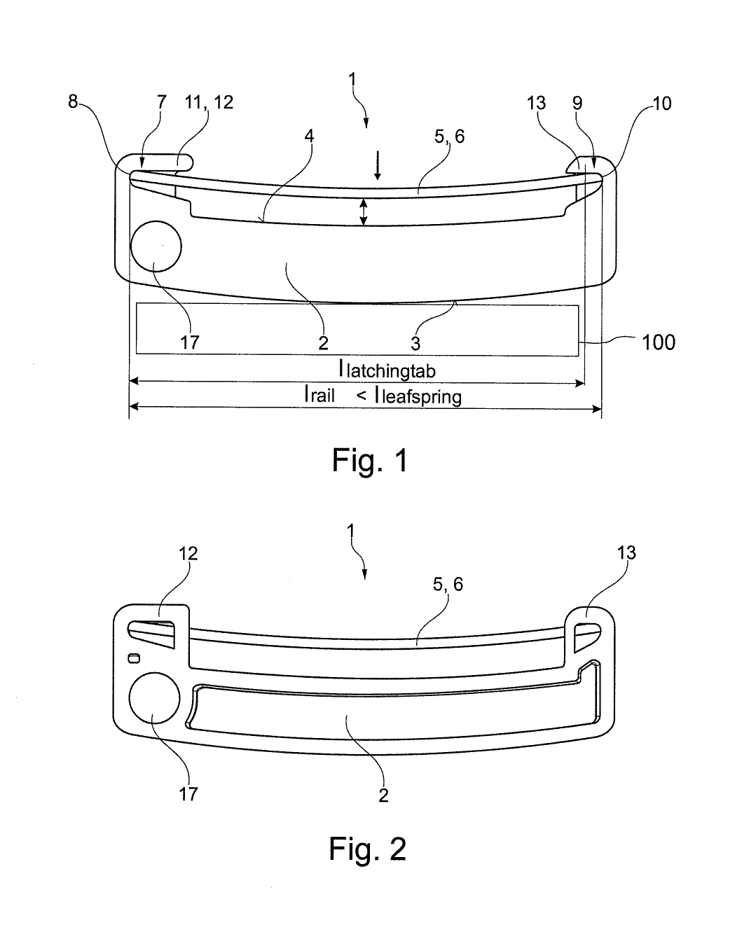

FIG. 1 shows a first embodiment of a traction means tensioner 1 according to the invention. The traction means tensioner 1 is intended for use in a traction means drive of an internal combustion engine.

The traction means tensioner 1 also has a tensioning element 2. The tensioning element 2 can be made of plastic. The tensioning element 2 has a front 3 that makes contact with the traction means or device 100, shown solely schematically. The tensioning element 2 also has a rear 4 facing away from the traction means.

Moreover, the traction means tensioner 1 has a spring 5 that is configured as a leaf spring 6. The leaf spring 6 is made of spring steel. The spring 5 has a first end 7 with a first end edge 8. The leaf spring 6 also has a second end 9 with a second end edge 10. The two end edges 8 and 10 run perpendicular to the lengthwise direction of the leaf spring 6, preferably orthogonally to it.

The first end 7 of the spring 5 is positively affixed to a rear holding section 11 of the tensioning element 2. The holding section 11 is configured as a first projection 12.

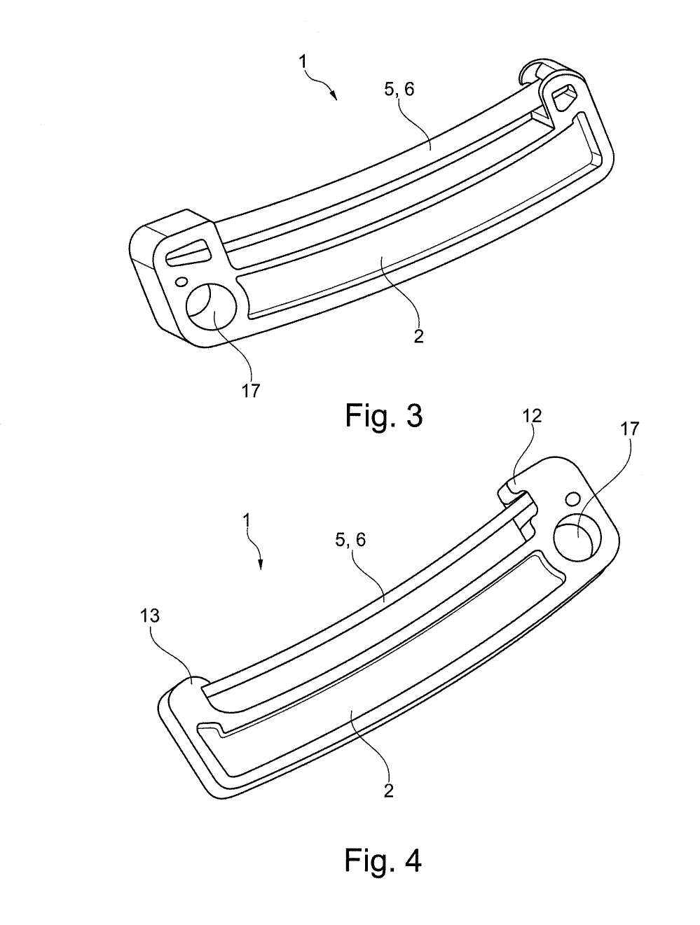

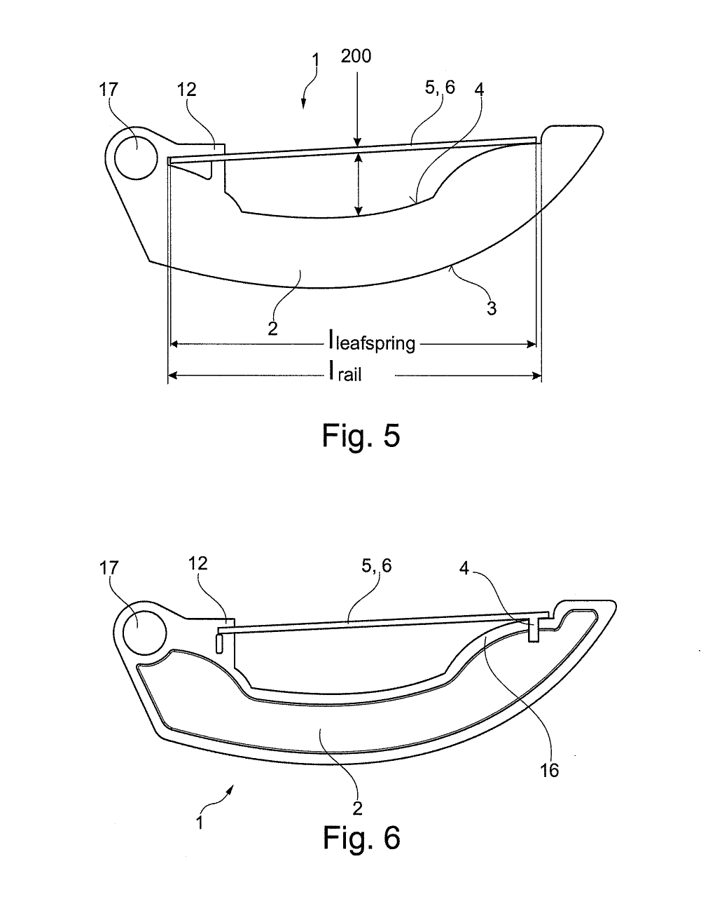

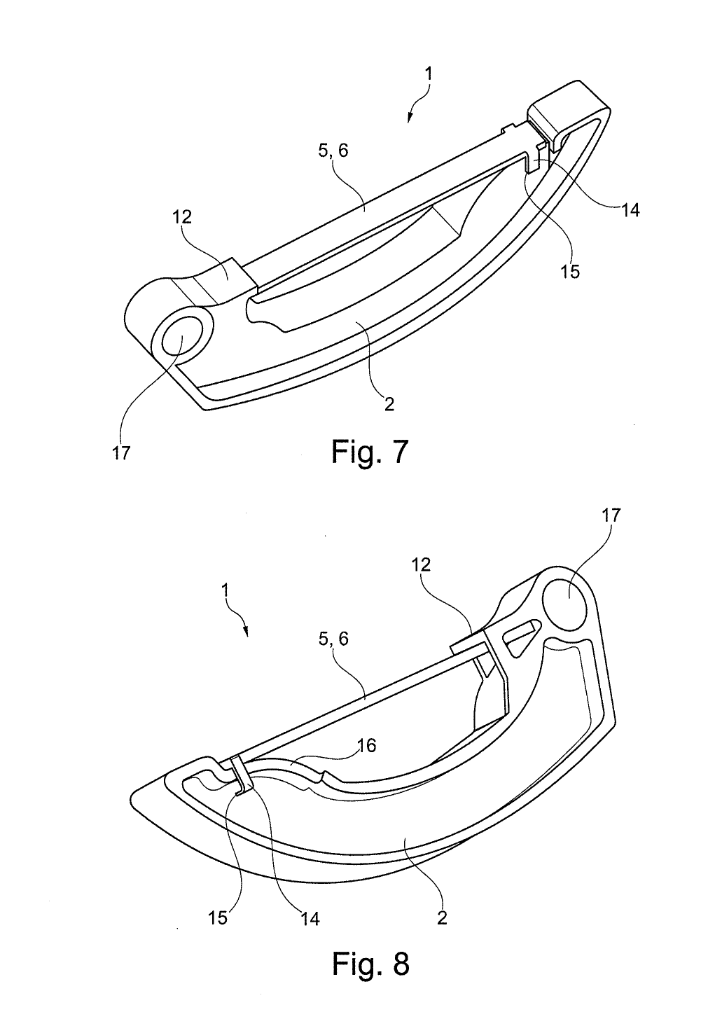

The second end 9 of the spring 5 is affixed to the rear 4 of the tensioning element 2 by means of a snap-on and/or clip-on connection. For this purpose, a second projection 13 is employed in the variant shown in FIGS. 1 to 4. In addition or as an alternative to this, it is also possible to use one or both of the hooks 14, as shown in the variant from FIGS. 5 to 8. These figures also show that the ends 15 of the hooks 14 that are bent towards each other extend behind an edge 16 of the tensioning element that projects to the outside. The edge 16 can be part of a structure that forms a recess and/or a groove into which the ends 15 of the hooks 14 engage.

Returning to the embodiment of FIGS. 1 to 4, it can be explained in other words that, in this variant, the leaf spring 6 is inserted into two wraparounds. Here, first of all, the leaf spring 6 is inserted into the long wraparound and subsequently pressed onto the center of the leaf spring 6, which allows it to latch into the second wraparound. This secures the leaf spring 6 against falling out. Owing to the two continuous wraparounds that are laterally offset, the leaf spring is secured particularly well against falling out sideways while, at the same time, the weight of the traction means tensioner 1 is reduced.

It is advantageous if l_{leafspring} is greater than l_{latchingtab} but smaller than lᵣₐᵢₗ. In special cases, l_{leafspring} can also be greater than lᵣₐᵢₗ, which causes the leaf spring to be pre-tensioned already when it is put in place. If larger pre-tensioning forces are needed, the use of several leaf springs 6 in the form of a leaf spring packet should be considered.

FIGS. 2 to 4 clearly show that the channels formed by the two projections 12 and 13 are closed at different sides of the tensioning element 2.

Whereas in the embodiments shown in FIGS. 1 to 4, both ends of the leaf spring 6—especially both end edges 8 and 10 situated at the respective ends—are in contact with the tensioning element 2, this is not necessary in the variant shown in FIGS. 5 to 8. Here, only the first end edge 8 is close to the tensioning element 2, and may contact it. In the case of the variant shown in FIGS. 5 to 8, the leaf spring 6 is secured by a wraparound and by two lateral hooks 14 located on the leaf spring 6.

First of all, the leaf spring 6 is inserted into the long wraparound and subsequently pressed into the center of the leaf spring 6, which causes the lateral hooks 14 to latch into the tensioning element 2, the latter also being the base element of the component that serves as the tensioning rail. Due to the laterally offset long wraparound and due to the two lateral hooks, the leaf spring 6 is secured against falling out sideways. l_{leafspring} should be smaller than lᵣₐᵢₗ.

The invention can and should be used as a drive tensioner for oil pumps and differential gear shafts. The traction means tensioner 1 can be pivoted around the center of a bearing hole 17 in the manner of a tensioning rail, and the spring can be contacted by a support element 200 shown schematically in FIG. 5.

The terms traction means and traction device are used interchangeably herein, and define a specific structure such as a belt or chain.

### LIST OF REFERENCE NUMERALS

1 traction means tensioner
2 tensioning element
3 front that makes contact with the traction means
4 rear
5 spring
6 leaf spring
7 first end
8 first end edge
9 second end
10 second end edge
11 holding section
12 first projection
13 second projection
14 hook
15 end of the hook
16 edge
17 bearing hole
100 traction device
200 support element

What is claimed is:

1. A traction device tensioner for a traction device drive of an internal combustion engine, comprising:
a tensioning element having a front contacting a traction device and a rear faces away from the traction device;
a spring positively affixed to the tensioning element and serving to make contact with a support element separate from the traction device tensioner, the spring having a first end positively affixed to a rear holding section of the tensioning element and a second end fastened to the rear of the tensioning element via a snap-on or clip connection.

2. The traction device tensioner as recited in claim 1 wherein the first end of the spring is surrounded, at least partially, by a first projection formed at the rear of the tensioning element.

3. The traction device tensioner wherein one or more hooks are formed on the spring, creating a positive connection to the tensioning element, or else a second projection is formed at the rear of the tensioning element, the second projection surrounding the second end of the spring, at least partially.

4. The traction device tensioner as recited in claim 3 wherein the second projection surrounds a second end edge of the spring, at least partially, in order to bring about a positive connection to the tensioning element.

5. The traction device tensioner as recited in claim 4 wherein the first projection extends further along the spring than the second projection.

6. The traction device tensioner as recited in claim 5 wherein the first projection is 1.5 to 5 times longer than the second projection as seen in the lengthwise direction of the spring.

7. The traction device tensioner as recited in claim 1 wherein the spring is a mechanical spring.

8. The traction device tensioner as recited in claim 7 wherein the mechanical spring is a leaf spring.

9. The traction device tensioner as recited in claim 1 wherein two hooks on both sides of the spring protrude in the direction of the tensioning element and extend behind the tensioning element, at least in certain sections.

10. The traction device tensioner as recited in claim 1 wherein the tensioning element has two sides with recesses, hooks of the spring engaging into the recesses.

11. A traction device drive comprising the traction means tensioner as recited in claim 1.
